(19) United States
(12) Patent Application Publication
(10) Pub. No.: US 2015/0006416 A1
(43) Pub. Date: Jan. 1, 2015

(54) Computer Implemented Systems and Methods for Interacting with Employee Data

(71) Applicants: Kai Xu, Palo Alto, CA (US); Michelangelo Capraro, Palo Alto, CA (US)

(72) Inventors: Kai Xu, Palo Alto, CA (US); Michelangelo Capraro, Palo Alto, CA (US)

(73) Assignee: SUCCESSFACTORS, INC., South San Francisco, CA (US)

(21) Appl. No.: 13/929,608

(22) Filed: Jun. 27, 2013

(51) Int. Cl. G06Q 10/10

(52) U.S. Cl. CPC G06Q 10/105
USPC 705/320

(57) ABSTRACT

The present disclosure includes systems and methods for interacting with employee data. In one embodiment, a computer may access a plurality of employee data records having a particular job function on a first date and a second date. The computer may display, in a first portion of a display, graphical elements corresponding to employee data records having the particular job function on the first date. The computer may display, in a second portion of the display, graphical elements corresponding to employee data records having the particular job function on the second date. One or more other portions of the display may include graphical elements corresponding to employee data records having the particular job function on only one of the first date and the second date together with one or more corresponding graphical elements indicating reasons for a changed job function.

### BACKGROUND

The present invention relates to computing and data processing, and in particular, to interacting with employee data.

The growth in computing power and mobility has placed almost unlimited amounts of data in the hands of users. Cloud computing systems and software as a service remove hardware and software complexities to data centers. Users access powerful backend data processing resources through home computers, laptops, mobile devices such as smartphones and tablets computers, and other emerging portable computing technologies. However, it is ever problematic to provide users with interfaces to data that make data easy to access and manipulate. As computational power increases and computing become ubiquitous, innovative user interface solutions are required that are engaging to the user, intuitive, and easy to manipulate.

In particular, tracking employees across large organizations is a challenging task for management. Embodiments of the present invention provide improved techniques for interacting with employee data.

### SUMMARY

The present disclosure includes systems and methods for interacting with employee data. In one embodiment, a computer may access a plurality of employee data records having a particular job function on a first date and a second date. The computer may display, in a first portion of a display, graphical elements corresponding to employee data records having the particular job function on the first date. The computer may display, in a second portion of the display, graphical elements corresponding to employee data records having the particular job function on the second date. One or more other portions of the display may include graphical elements corresponding to employee data records having the particular job function on only one of the first date and the second date together with one or more corresponding graphical elements indicating reasons for a changed job function.

In one embodiment, the present disclosure further comprises accessing, by the computer, a plurality of employee data records having the particular job function on a plurality of other dates, before said displaying in the first portion, the second portion, and the one or more other portions of the display, displaying, by the computer, in a plurality of portions of the display, graphical elements corresponding to employee data records having the particular job function on the first date, the second date, and the plurality of other dates, wherein the plurality of portions are displayed adjacent to each other by ascending date, receiving, by the computer, a selection of adjacent portions of the display having graphical elements for two sequential dates, and reconfiguring the display, by the computer, to perform said displaying in the first portion, the second portion, and the one or more other portions.

In one embodiment, the selection is a pinch out gesture.

In one embodiment, the graphical elements are profile images of particular employees.

In one embodiment, one or more of said employee data records are associated with at least one indication of a reason for a changed job function between the first date and the second date.

In one embodiment, the graphical elements indicating reasons for the changed job function include one or more of voluntary attrition, involuntary attrition, promotion, and new hire.

In one embodiment, the graphical elements corresponding to employee data records having the particular job function on only one of the first date and the second date are displayed in an attrition grouping or a growth grouping, wherein said attrition grouping includes employee data records that had the job function on the first date and not the second date and said growth grouping includes employee data records that had the job function on the second date and not the first date.

In one embodiment, the present disclosure further comprises changing the one of the first date or the second date from an initial date to a changed date and animating, by the computer, one or more graphical elements having the job function on the initial date but not the changed date and one or more graphical elements having the job function on the changed date but not the initial date.

In one embodiment, a plurality of the employee data records are associated with a risk of loss.

In one embodiment, the present disclosure further comprises, in response to a user selection, displaying a subset of the employee data records as graphical elements in a plurality of groups according to said associated risk of loss.

In another embodiment, the present disclosure includes a computer system comprising a processor and a non-transitory computer readable medium having stored thereon one or more programs, which when executed by the processor, causes the processor to perform the techniques set forth herein.

In another embodiment, the present disclosure includes a non-transitory computer readable storage medium storing one or more programs, the one or more programs comprising instructions for performing the techniques set forth herein.

The following detailed description and accompanying drawings provide a better understanding of the nature and advantages of the present disclosure.

### BRIEF DESCRIPTION OF THE DRAWINGS

FIG. 1 illustrates a user interface including interactive employee data according to an example embodiment of the present disclosure.

FIG. 1A illustrates a user interface according to another embodiment.

FIG. 2 illustrates a zoom in view of a display according to a particular embodiment.

FIG. 3A illustrates an example of a zoom in view of voluntary attrition according to a particular embodiment.

FIG. 3B illustrates a performance card according to a particular embodiment.

FIG. 4 illustrates an employee data analysis method according one embodiment.

FIG. 5 illustrated animation according to a particular embodiment.

FIG. 6 illustrates risk of loss according to a particular embodiment.

FIG. 7 illustrates an example implementation on a mobile device according to a particular embodiment.

FIG. 8 illustrates hardware of a special purpose computing machine configured with a process according to the above disclosure.

### DETAILED DESCRIPTION

Described herein are techniques for interacting with employee data. The apparatuses, methods, and techniques described below may be implemented as a computer program (software) executing on one or more computers. The computer program may further be stored on a tangible non-transitory computer readable medium, such as a memory or disk, for example. A computer readable medium may include instructions for performing the processes described below. In the following description, for purposes of explanation, numerous examples and specific details are set forth in order to provide a thorough understanding of the present invention. It will be evident, however, to one skilled in the art that the present invention as defined by the claims may include some or all of the features in these examples alone or in combination with other features described below, and may further include modifications and equivalents of the features and concepts described herein.

Embodiments of the present disclosure include a computer system programmed to allow users to interactively analyze employee data. Generally, organization leaders may want to visualize what happened to a group of managers or people having other job functions in a talent pool over time in a variety of ways. It is challenging to present such information in a concise and engaging manager. It is also difficult to show information from a variety of perspectives without disorienting the audience. Features and advantages of the present disclosure accessing and displaying employee data to show the movement of people over time. For example, a computer may access a plurality of employee data records having a particular job function on a first date and having the particular job function on a second date. The computer may display graphical elements corresponding to employee data records having the particular job function on the first date in a first portion of the display (e.g., a cohort). The computer may display graphical elements corresponding to employee data records having the particular job function on the second date. The computer may further display graphical elements corresponding to employee data records having the particular job function on only one of the first date and the second date, for example, to show the changes over time. The changes may be displayed together with one or more corresponding graphical elements indicating reasons for a changed job function, such as a promotion or a new hire, for example. Accordingly, embodiments of the present disclosure may be used to track the movement of employees as their careers unfold at a particular organization, which may allow improved management of human resources at an organization, for example.

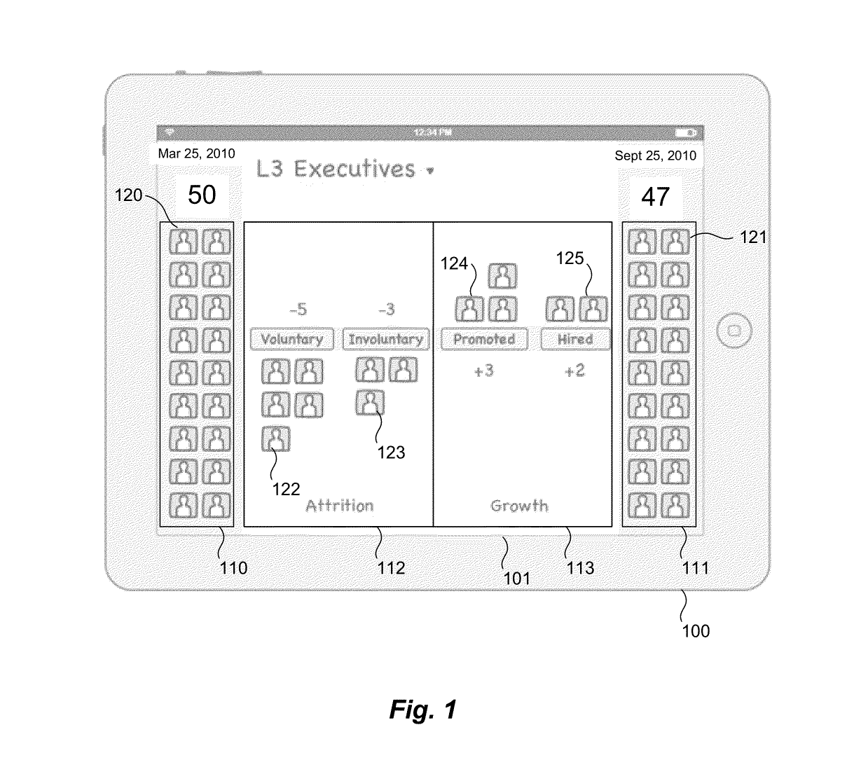

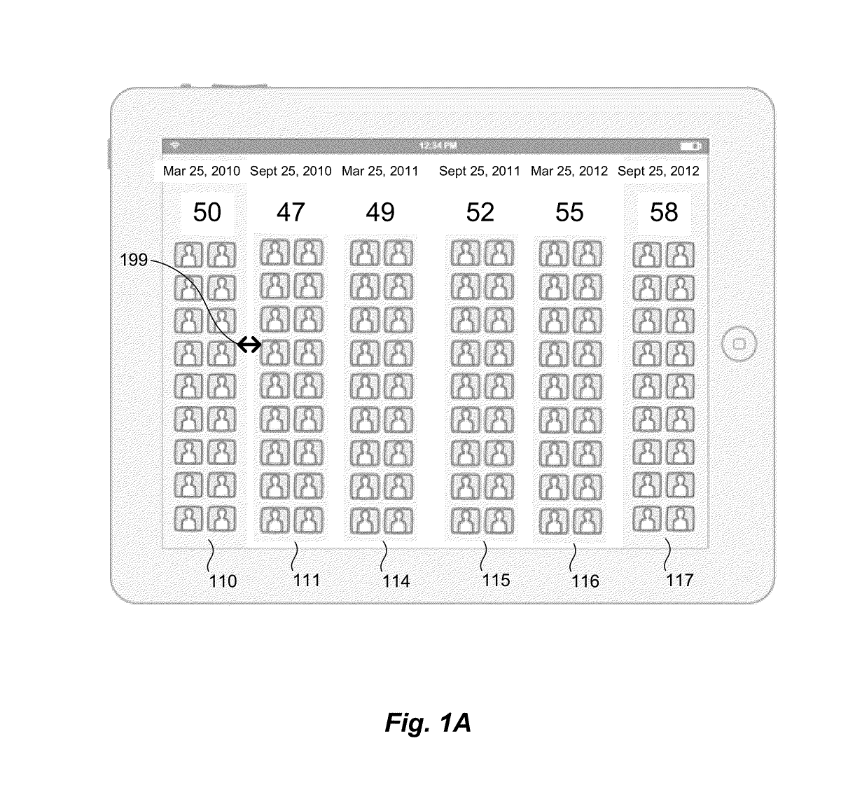

FIG. 1 illustrates a user interface including interactive employee data according to an example embodiment of the present disclosure. In this example, graphical elements (e.g., 120-125) corresponding to employee data records are presented in a display 101 of a mobile computing device 100, such as a tablet computer. For instance, employee data records may be stored in a local database. Graphical elements, such as profile pictures, may be associated with the employee data records, for example. The present example illustrates the movement of employees across two dates (e.g., Mar. 25, 2010 to Sep. 25, 2010) for the “L3 Executive” job function.

Some embodiments may access employee data records having a particular job function (e.g., L3 Executive) on two different dates (e.g., Mar. 25, 2010 and Sep. 25, 2010). As mentioned above, the employee data records may have associated graphical elements, such as profile pictures or other images, that may be stored with each data record (e.g., in a database) or stored in another form of object storage, for example. The graphical elements represent the employee and related employee data in the display.

In this example, there are 50 employees who were L3 Executives (herein, “L3”) on Mar. 25, 2010, such as an employee represented by graphical element 120, and 47 employees who had the L3 job function on Sep. 25, 2010, such as an employee represented by graphical element 121. Graphical elements corresponding to employee data records having the L3 job function on the first date are displayed by the computer in a first portion of a display 110. Similarly, graphical elements corresponding to employee data records having the L3 job function on the second date are displayed by the computer in a second portion of a display 111. In this example, the employees in the L3 cohort at the beginning of the time frame are arranged in two columns on the left hand side of the display, and the employees in the L3 cohort at the end of the particular time frame are arranged in two columns on the right hand side of the display.

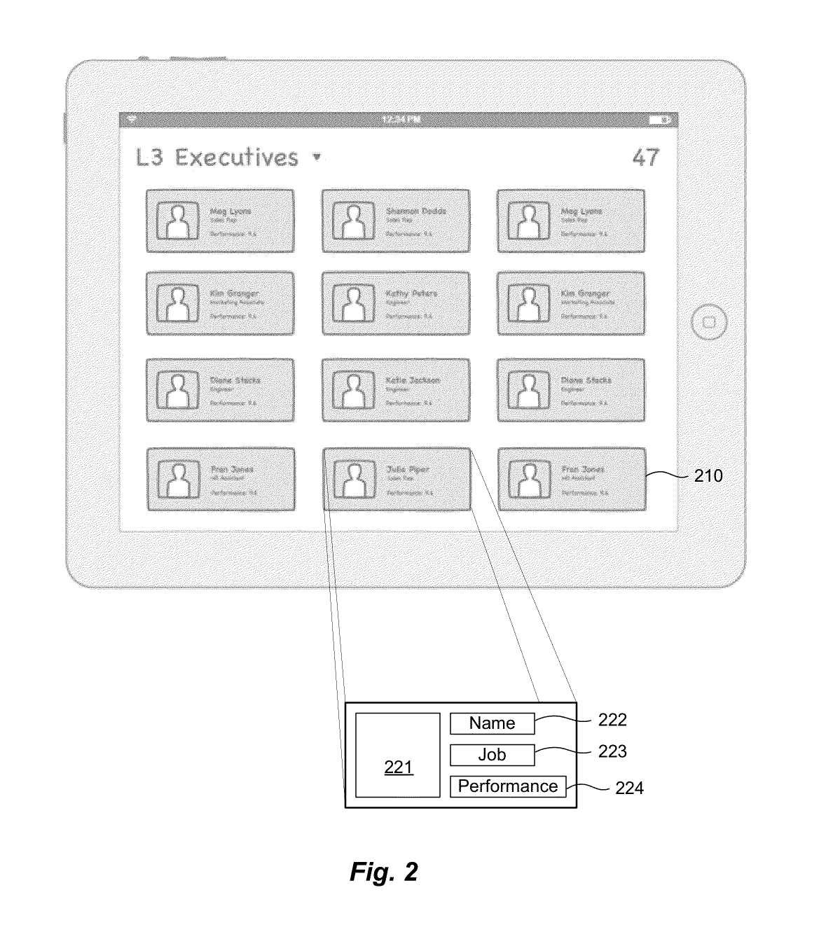

Each portion 110 and 111 of the display may only display some of the employees having the job function on the particular date because the total number of graphical elements may not fit in the specified portion of the display. A user may scroll or swipe the display at 110 or 111 to view other graphical elements within the group shown in portions 110 or 111, for example. In some embodiments, a user may select the portions 110 or 111 of the screen to bring up a full display (or alternatively, a popup window) of the employees in the group. FIG. 2 illustrates a display that shows 12 of the 47 employees having the L3 job function on Sep. 25, 2010. When a user selects display portion 111, the computing device may display graphical elements with additional employee data about each employee in the group. For example, each employee in the L3 group on Sep. 25, 2010 may be represented in the display using a performance card graphic 210, which may include a profile picture 221, employee name 222, job title 223, and performance score 224. In this example, 12 of the 47 performance cards are presented in the display at one time. A user may scroll or swipe the display, for example, to view additional performance cards for other employees in the group. If a user selects one of the performance cards, the display may bring up additional detail about the particular employee as described further below.

Referring again to FIG. 1, embodiments of the present disclosure allow users to quickly understand the movement of people in an organization. For example, other portions of the display may include graphical elements corresponding to employee data records having the L3 job function on only one of the first date and the second date together with one or more corresponding graphical elements indicating reasons for a changed job function. For instance, there may be 50 employees in the L3 cohort on Mar. 25, 2010, but only 47 in the L3 cohort on Sep. 25, 2010. In this example, employees who either left the cohort or joined the cohort are displayed in only one of portions 110 and 111. These employees are also displayed, in this example, in an intermediate portion 112 and 113 of the display between portions 110 and 111 together with corresponding graphical elements indicating reasons for a changed job function.

In one embodiment, employee data records are associated with an indication of a reason for a changed job function between the first date and the second date. For example, for each employee that joined or exited the L3 cohort, there may be an indication of a reason for the change associated with the data record. For instance, employee data records may be associated with text or logic indicating that an employee has voluntarily resigned from a cohort, involuntarily been fired from a cohort, been promoted into a cohort, or been newly hired into a cohort. For example, 5 graphical elements for employees are displayed together with a graphical element “Voluntary” indicating that the employee data records, such as employee 122, are associated with an indicator that the employee voluntarily left the L3 job function. Similarly, 3 graphical elements for employees are displayed together with a graphical element “Involuntary” indicating that the employee data records, such as employee 123, are associated with an indicator that the employee left the L3 job function involuntarily. Likewise, 3 graphical elements for employees are displayed together with a graphical element “Promoted” indicating that the employee data records, such as employee 124, are associated with an indicator that the employee joined the L3 job function cohort as a result of a promotion. Lastly, 2 graphical elements for employees are displayed together with a graphical element “Hired” indicating that the employee data records, such as employee 125, are associated with an indicator that the employee joined the L3 job function cohort as a result of being newly hired into the organization, for example.

The intermediate portion may be presented as a balance sheet, for example, showing which employees left the cohort (a debit) and which employees entered the cohort (a credit). FIG. 1 further illustrates that graphical elements may be grouped in the display. For example, employee data records having the L3 job function on only one of the specified dates may be displayed in an attrition grouping 112 or a growth grouping 113. The attrition grouping includes employee data records that had the job function on the first date (e.g., Mar. 25, 2010) and not the second date. Graphic elements for these employees are shown below the Voluntary and Involuntary attrition categories with negative numbers above (e.g., a debit format). The growth grouping includes employee data records that had the job function on the second date (Sep. 25, 2010) and not the first date. Graphic elements for these employees are shown above the Promoted and Hired growth categories with positive numbers below (e.g., a credit format).

In one embodiment, employee data records may be displayed in a preceding screen the leads to the screen in FIG. 1. FIG. 1A illustrates displaying employee data records have the L3 job function on the dates above (Mar. 25, 2010 and Sep. 25, 2010) and a plurality of other dates. For each date, a number of employees having the L3 job function is shown along with graphical elements representing each employee. Before displaying the configuration in FIG. 1, the computer may display graphical elements representing employees in adjacent portions by ascending dates, such as portion 110 for Mar. 25, 2010, portion 111 for Sep. 25, 2010, portion 114 for Mar. 25, 2011, portion 115 for Sep. 25, 2011, portion 116 for Mar. 25, 2012, and portion 117 for Sep. 25, 2012. In some embodiments, a user may scroll to different dates by swiping the screen, for example, in either direction, or change the dates or a date range. From the display shown in FIG. 1A a user can quickly see that there was steady growth in employees except for between Mar. 25, 2010 and Sep. 25, 2010. Accordingly, a user may obtain additional information about what happened between two dates by selecting adjacent portions of the display having graphical elements for two sequential dates, such as selecting adjacent portions 110 and 111 at 199. Selection may be made, for example, using a pinch out gesture, a screen tap (or double tap), or a mouse click. Accordingly, the display is reconfigured by the computer to perform said displaying set forth in FIG. 1. For example, if the graphical elements are displayed as arrays rectangular portions, as in FIG. 1A, when a user selects a region between two rectangular portions, the rectangular portions may animate sideways. For example, portion 111 may move to the right with portions 114-117. Portions 114-117 disappear from the display one by one as portion 111 moves to the right. The central portions 112 and 113 from FIG. 1 may animate into the screen emanating from the growing space between portions 110 and 111, for example.

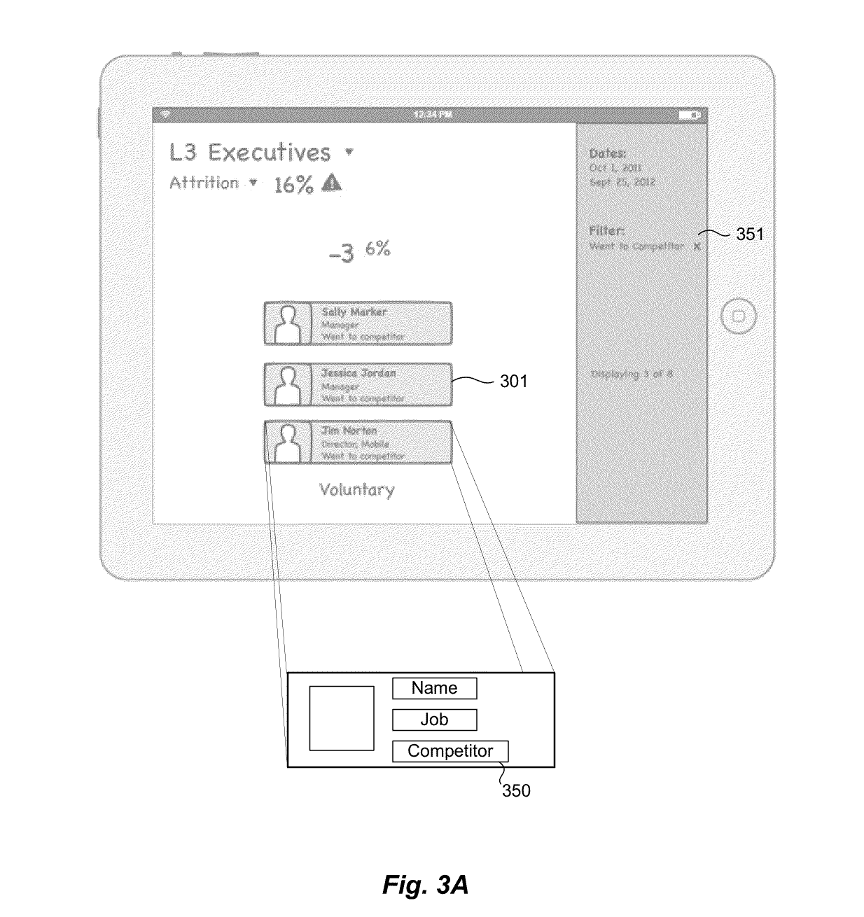

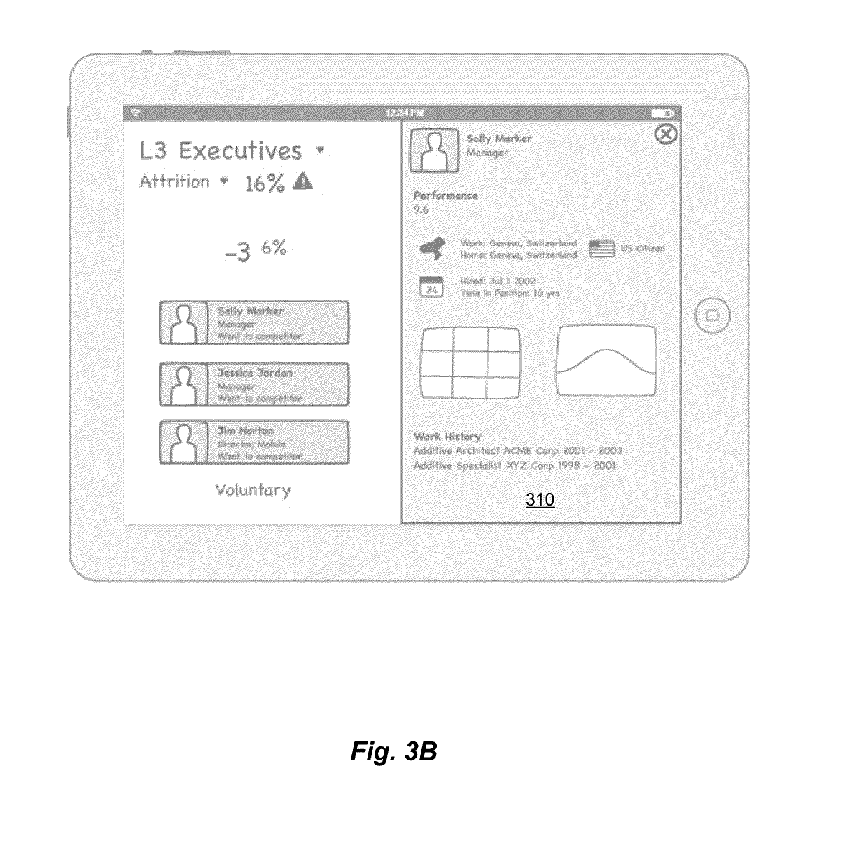

Embodiments of the present disclosure may allow a user to zoom, sort, and/or filter the employee data. FIG. 3A illustrates an example where a user selects the Voluntary portion of the display to show detailed information about the people that left voluntarily. The user can also sort these people based on different criteria, for example, such as the reason these people left. In this example, the graphical elements are presented based on the portion of the previous display (FIG. 1) selected. In this case, a user selected the Voluntary attrition portion of the display. Therefore, graphical elements 301 are configured to display information about the voluntary attrition. For instance, graphical elements may include an indication that the employee went to competitor at 350 and the name of the competitor at 351. Users may filter by competitors to determine if particular competitors are a source of attrition, for example.

In this way, users may quickly analyze trends in voluntary or other reasons for attrition or growth. FIG. 3B illustrates a detailed performance card 310 for a particular employee that may be selected. The detailed performance card 310 may display a profile picture, the name of the employee, job function, performance score, and work history, for example.

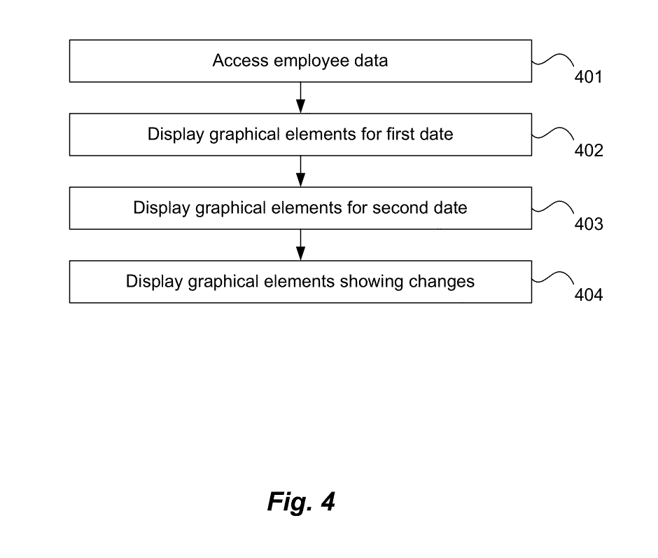

FIG. 4 illustrates an employee data analysis method according one embodiment. At 401, employee data may be accessed. In one embodiment, the employee data may be stored as records in a database, for example. Equivalently, the employee data may be stored using a variety of other known data storage techniques, such as objects, files, etc . . . . The employee data may include graphical elements, such as profile pictures, associated with each particular employee's data. At 402, graphical elements for the employee data matching a particular criteria on a particular date are displayed in a user interface. The criteria may be a particular job function as described above, for example, with the graphical elements representing employees having the particular job function on a particular date being displayed together in a first portion of the display. At 403, graphical elements for the employee data matching the particular criteria on a second date are displayed in a user interface. The second group of graphical elements (e.g., profile pictures) may be displayed together in a second portion of the display. At 404, graphical elements showing changes in the criteria are displayed so that, in one example embodiment, a user can simultaneously view the employees meeting the criteria on two different dates and view information about how the employees status changed over time. Information about reasons for the changes in the criteria may be displayed, such as reasons for entering or leaving a job function as described above, for example.

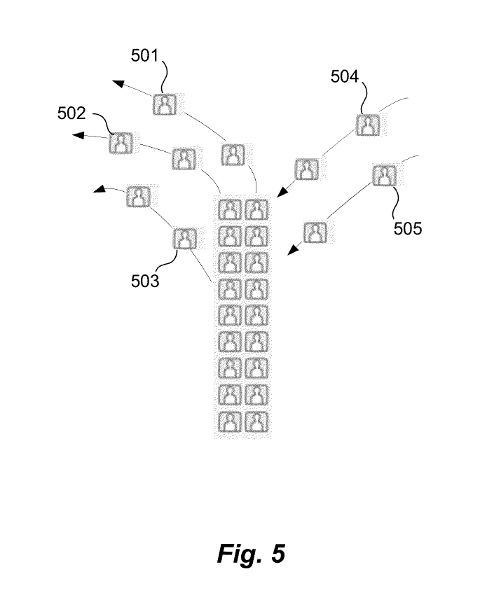

FIG. 5 illustrates animation according to a particular embodiment. Features and advantages of some embodiments of the present disclosure may include animating graphical elements in response to input from a user, such as profile pictures as the display is reconfigured. For example, referring to FIG. 1, if a date is changed for either group 110 or 111, then the computer may animate graphical elements to show the changes. The computer may animate one or more graphical elements having a particular job function on an initial date but not on a changed date, for example, and one or more graphical elements having the job function on the changed date but not the initial date. For instance, employee pictures that are no longer in the group after the date change may be animated to fly out of the group along a trajectory as illustrated at 501-503. Similarly, employee pictures that are now part of the group may be animated to fly into the group as illustrated at 504-505. Similar animation may be used as graphical elements move (fly) to the intermediate portions of the display for Voluntary/Involuntary/Promoted/Hired sections as the data is updated or as the display zooms in on particular portions, for example, changing the elements displayed. Traditional user interface solutions show different views of data without showing the transition of what happened in between changes. The pages typically go blank and then shows a very different view, which can be disorienting to the viewer. Some embodiments of this disclosure make sure all transitions are smoothly animated to allow the user to comprehend what is happening. Smooth animation also increases user engagement and adoption. This feature also allows user to bring up additional data while retaining the context of why they are looking at this data to aid comprehension.

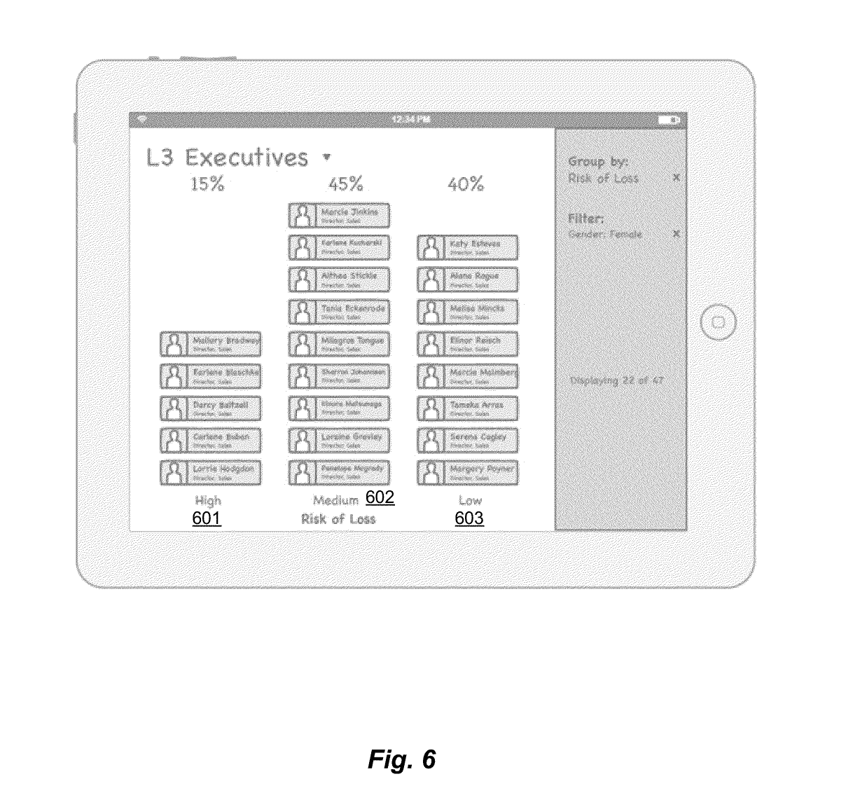

FIG. 6 illustrates risk of loss according to a particular embodiment. Some embodiments of the present disclosure may associate a risk of loss with each employee data record. A variety of factors may be used to determine a risk of loss—i.e., that an employee may leave the organization. Active employee data records for current employees may have different associated risks of loss. As illustrated in FIG. 6, graphical elements corresponding to different employees may be grouped according to risk of loss. In this example, a first group 601 is displayed together as a high risk of loss group, a second group 602 is displayed together as a medium risk of loss group, and a third group 603 is displayed together as a low risk of loss group. Risk of loss may be expressed as one of a limited number of identifiers (e.g., as here, low, medium, high) or as a number (or score), for example, where different records are grouped together based on ranges for the associated risk of loss score (e.g., high risk of loss=score>80; low risk of loss=score<20). Accordingly, a user may sort and filter a population of people or data in a variety of ways. In this example, the user sorted the 47 people based on the Risk of Loss criteria. Whenever a view is changed (sort, filter, drill down, pull up), the employee profile pictures, for example, may animate into the new view in a continuous manner using the technique described above.

### Example Hardware

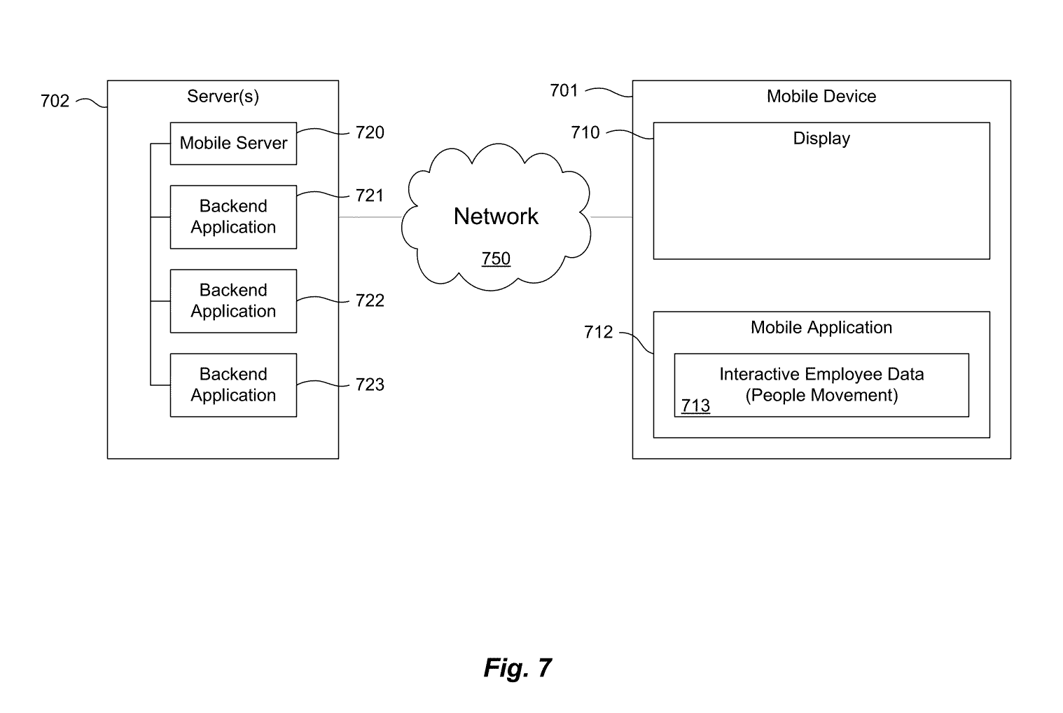

FIG. 7 illustrates an application including a people movement program operating on a mobile computing device according to one embodiment. A mobile computing device is just an example of a type of computer that may be used to perform the features disclosed herein. In some embodiments, the features described herein may be implemented on one or more backend servers (e.g., as a software service presented through a browser), on client computer, or as a combination thereof. In the example illustrated in FIG. 7, a mobile computing device 701 (or just, “mobile device”) executes a mobile application 712. Mobile device 701 may be a mobile phone, such as a smartphone, or a tablet computer, for example. Such mobile devices may include one or more processors and memory for storing instructions to perform a wide variety of features and functions, including the features described herein. For example, mobile application 712 may include an interactive employee data (People Movement) software component for interacting with employee data as described herein. Mobile device 701 may connect to other remote systems such as one or more servers 702 over a network 750, for example. Network 750 is illustrative of one or more networks for communicating information with other computer systems, such as a cellular communication network, an Ethernet network, the Internet, or a wireless network, for example. Mobile application 712 executing on mobile device 701 may receive and send data from one or more remote systems or from a user via a user interface including display 710, for example. In this example, mobile application 712 may communicate with a mobile server 720. Mobile server 720, in turn, may act as an interface between mobile application 712 and backend applications 721-723.

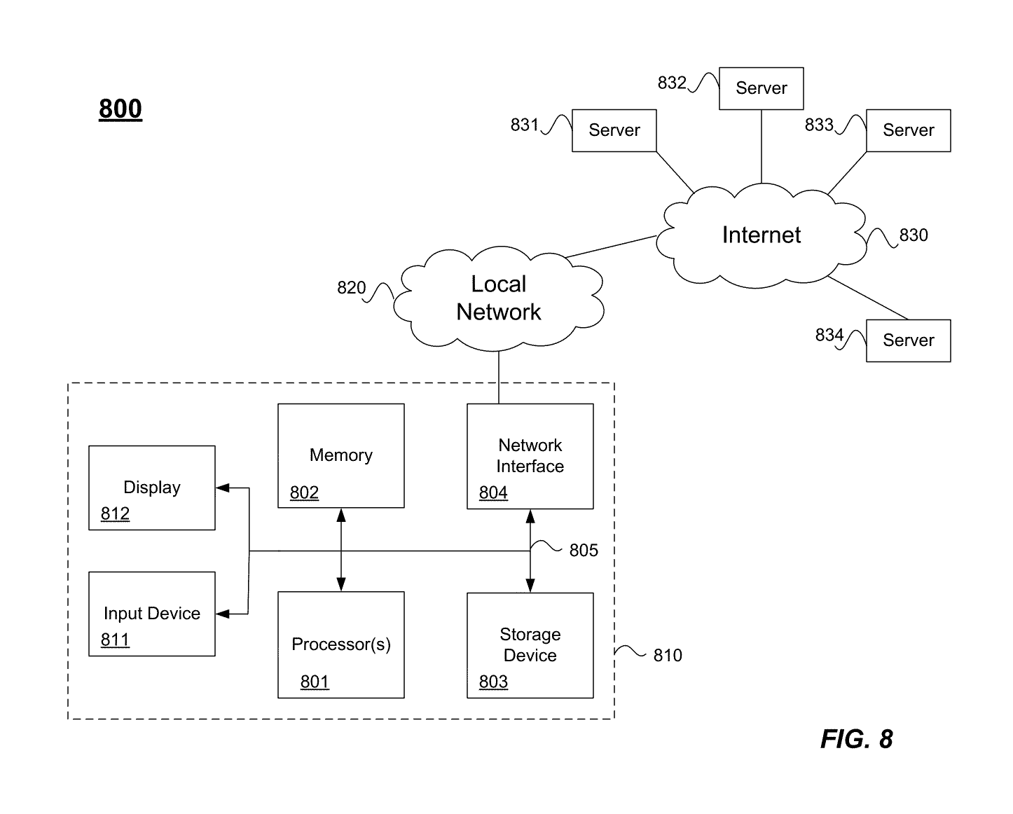

FIG. 8 illustrates hardware of a special purpose computing machine configured with a process according to the above disclosure. The following hardware description is merely one example. It is to be understood that a variety of computer topologies may be used to implement the above described techniques. An example computer system 810 is illustrated in FIG. 8. Computer system 810 includes a bus 805 or other communication mechanism for communicating information, and one or more processor(s) 801 coupled with bus 805 for processing information. Computer system 810 also includes a memory 802 coupled to bus 805 for storing information and instructions to be executed by processor 801, including information and instructions for performing some of the techniques described above, for example. This memory may also be used for storing programs executed by processor 801. Possible implementations of this memory may be, but are not limited to, random access memory (RAM), read only memory (ROM), or both. A storage device 803 is also provided for storing information and instructions. Common forms of storage devices include, for example, a hard drive, a magnetic disk, an optical disk, a CD-ROM, a DVD, a flash or other non-volatile memory, a USB memory card, or any other medium from which a computer can read. Storage device 803 may include source code, binary code, or software files for performing the techniques above, for example. Storage device and memory are both examples of non-transitory computer readable storage mediums.

Computer system 810 may be coupled via bus 805 to a display 812 for displaying information to a computer user. An input device 811 such as a keyboard, touchscreen, and/or mouse is coupled to bus 805 for communicating information and command selections from the user to processor 801. The combination of these components allows the user to communicate with the system. Bus 805 may represent multiple specialized buses and digital communication channels, for example.

Computer system 810 also includes a network interface 804 coupled with bus 805. Network interface 804 may provide two-way data communication between computer system 810 and a local network 820. The network interface 804 may be a wireless or wired connection, for example. Computer system 810 can send and receive information through the network interface 804 across a local area network, an Intranet, a cellular network, or the Internet, for example. One example implementation may include matrix pinch program code executing on a computing system 810 as described above. In the Internet example, a people movement software component, for example, may access employee data on backend systems that may reside on multiple different hardware servers 831-835 across the network. Servers 831-835 and server applications may also reside in a cloud computing environment, for example.

The above description illustrates various embodiments of the present invention along with examples of how aspects of the present invention may be implemented. The above examples and embodiments should not be deemed to be the only embodiments, and are presented to illustrate the flexibility and advantages of the present invention as defined by the following claims. Based on the above disclosure and the following claims, other arrangements, embodiments, implementations and equivalents will be evident to those skilled in the art and may be employed without departing from the spirit and scope of the invention as defined by the claims.

What is claimed is:

1. A method comprising:
accessing, by a computer, a plurality of employee data records having a particular job function on a first date and having the particular job function on a second date;
displaying, by the computer, in a first portion of a display, graphical elements corresponding to employee data records having the particular job function on the first date;
displaying, by the computer, in a second portion of the display, graphical elements corresponding to employee data records having the particular job function on the second date; and
displaying, by the computer, in one or more other portions of the display, graphical elements corresponding to employee data records having the particular job function on only one of the first date and the second date together with one or more corresponding graphical elements indicating reasons for a changed job function.

2. The method of claim 1 further comprising:
accessing, by the computer, a plurality of employee data records having the particular job function on a plurality of other dates;
before said displaying in the first portion, the second portion, and the one or more other portions of the display,
displaying, by the computer, in a plurality of portions of the display, graphical elements corresponding to employee data records having the particular job function on the first date, the second date, and the plurality of other dates, wherein the plurality of portions are displayed adjacent to each other by ascending date;
receiving, by the computer, a selection of adjacent portions of the display having graphical elements for two sequential dates; and
reconfiguring the display, by the computer, to perform said displaying in the first portion, the second portion, and the one or more other portions.

3. The method of claim 2 wherein the selection is a pinch out gesture.

4. The method of claim 1 wherein the graphical elements are profile images of particular employees.

5. The method of claim 1 wherein one or more of said employee data records are associated with at least one indication of a reason for a changed job function between the first date and the second date.

6. The method of claim 1 wherein the graphical elements indicating reasons for the changed job function include one or more of voluntary attrition, involuntary attrition, promotion, and new hire.

7. The method of claim 1 wherein the graphical elements corresponding to employee data records having the particular job function on only one of the first date and the second date are displayed in an attrition grouping or a growth grouping, wherein said attrition grouping includes employee data records that had the job function on the first date and not the second date and said growth grouping includes employee data records that had the job function on the second date and not the first date.

8. The method of claim 1 further comprising:
changing the one of the first date or the second date from an initial date to a changed date; and
animating, by the computer, one or more graphical elements having the job function on the initial date but not the changed date and one or more graphical elements having the job function on the changed date but not the initial date.

9. The method of claim 1 wherein a plurality of the employee data records are associated with a risk of loss.

10. The method of claim 9 further comprising, in response to a user selection, displaying a subset of the employee data records as graphical elements in a plurality of groups according to said associated risk of loss.

11. A computer system comprising:
a processor; and
a non-transitory computer readable medium having stored thereon one or more programs, which when executed by the processor, causes the processor to:
access a plurality of employee data records having a particular job function on a first date and having the particular job function on a second date;
display in a first portion of a display, graphical elements corresponding to employee data records having the particular job function on the first date;
display in a second portion of the display, graphical elements corresponding to employee data records having the particular job function on the second date; and
display in one or more other portions of the display, graphical elements corresponding to employee data records having the particular job function on only one of the first date and the second date together with one or more corresponding graphical elements indicating reasons for a changed job function.

12. The computer system of claim 11 wherein the graphical elements are profile images of particular employees.

13. The computer system of claim 11 wherein one or more of said employee data records are associated with at least one indication of a reason for a changed job function between the first date and the second date, said at least one indication comprising one of voluntary attrition, involuntary attrition, promotion, and new hire, and wherein the graphical elements indicating reasons for the changed job function include one or more of voluntary attrition, involuntary attrition, promotion, and new hire.

14. The computer system of claim 11 wherein the programs further causing the processor to animate one or more graphical elements in response to input from a user.

15. The computer system of claim 11 wherein the employee data records are associated with a risk of loss, the programs further causing the processor to display, in response to a user selection, a subset of the employee data records as graphical elements in a plurality of groups according to said associated risk of loss.

16. A non-transitory computer readable storage medium storing one or more programs, the one or more programs comprising instructions for:
accessing a plurality of employee data records having a particular job function on a first date and having the particular job function on a second date;
displaying in a first portion of a display, graphical elements corresponding to employee data records having the particular job function on the first date;
displaying in a second portion of the display, graphical elements corresponding to employee data records having the particular job function on the second date; and
displaying in one or more other portions of the display, graphical elements corresponding to employee data records having the particular job function on only one of the first date and the second date together with one or more corresponding graphical elements indicating reasons for a changed job function.

17. The non-transitory computer readable storage medium of claim 16 wherein the graphical elements are profile images of particular employees.

18. The non-transitory computer readable storage medium of claim 16 wherein one or more of said employee data records are associated with at least one indication of a reason for a changed job function between the first date and the second date, said at least one indication comprising one of voluntary attrition, involuntary attrition, promotion, and new hire, and wherein the graphical elements indicating reasons for the changed job function include one or more of voluntary attrition, involuntary attrition, promotion, and new hire.

19. The non-transitory computer readable storage medium of claim 16 wherein instructions are further for animating one or more graphical elements in response to input from a user.

20. The non-transitory computer readable storage medium of claim 16 wherein the employee data records are associated with a risk of loss, wherein the instructions are further for displaying, in response to a user selection, a subset of the employee data records as graphical elements in a plurality of groups according to said associated risk of loss.
